(19) United States
(12) Patent Application Publication
(10) Pub. No.: US 2022/0320787 A1
(43) Pub. Date: Oct. 6, 2022

(54) COMBINED UPPER COVER FOR A POWER STRIP

(71) Applicant: Jiangsu General Protecht Co., Ltd., Suzhou, JiangSu (CN)

(72) Inventors: Hua YAN, Suzhou, JiangSu (CN); Bin CHEN, Suzhou, JiangSu (CN); Sufeng CAI, Suzhou, JiangSu (CN)

(21) Appl. No.: 17/640,182

(22) PCT Filed: Aug. 27, 2020
(86) PCT No.: PCT/CN2020/000191

§ 371 Date: Mar. 3, 2022

(30) Foreign Application Priority Data
Sep. 11, 2019 (CN) 201921513679.9

(51) Int. Cl. H01R 13/518

(52) U.S. Cl. CPC H01R 13/518; H01R 27/02

(57) ABSTRACT

The present invention provides a combined upper cover for a power strip, which is formed by combining a first upper cover and a second upper cover. The first upper cover is provided with a cover body portion and a connecting portion, both the cover body portion and the connecting portion are thin-walled shells with an accommodating space and an open bottom, and the bottoms of the sidewalls of the connecting portion form blocking surfaces connected to the second upper cover in a snap-fit manner. The second upper cover is a thin-walled shell with an accommodating space and an open bottom and one open side, and is mounted on the connecting portion in a snap-fit manner. A plurality of wedged retaining teeth are projected from the inner surface of the sidewall of the second upper cover, and can abut against the blocking surfaces to form snap-fit connection. According to the present invention, since the housing is assembled by the snap-fit fasteners in a snap-fit manner, a more stable and firmer connection can be obtained so as to avoid disconnection caused by threads getting loose that may occur in threaded connection. Moreover, different colors can be sprayed on the separated upper cover assembly, improving product recognizability.

### TECHNICAL FIELD

The present invention relates to the field of electric connection devices, and in particular to a combined upper cover for a power strip.

### BACKGROUND

The power strip is a connector between an electrical device and a power supply, and can extend one power aperture to form a multi-socket adapter so as to supply power to multiple electrical devices at the same time, so that the power strip is an essential article in daily life. With the continuous improvement of residents' economic and living standards, the number of household appliances and communication tools is increasing sharply, which makes people more and more dependent on power strips, so the demand on power strips is further increased.

At present, most of the power strips in the market are made of plastic materials for the housings which are assembled by threaded connection. Because of the threaded connection, installation holes must be arranged in the housing of the power strip, which seriously affects the integrity of the appearance of the power strip. Further, there is the possibility of screws getting loose. Once the screws get loose, the housings are separated, which will cause potential safety hazards to users.

In addition, at present, the power strip in the market is generally composed of an upper cover and a bottom board, and the upper cover is a main exhibited panel. However, due to the limitation of manufacturing cost and technological capability, the upper cover is of a one-piece structure and generally has only one color, which leads to low product recognizability.

### SUMMARY

The object of the invention is to provide a combined upper cover for a power strip, which provides stable connection and, at the same time, enables the power strip to be formed by combining two plastic materials with different colors, so as to increase the recognizability of the power strip.

In order to achieve the above object, the present invention adopts the following technical solution:

A combined upper cover for a power strip formed by combining a first upper cover and a second upper cover; wherein

the first upper cover is provided with a cover body portion and a connecting portion integrally extending from the cover body portion, both the cover body portion and the connecting portion are thin-walled shells with an accommodating space and an open bottom, the bottoms of the sidewalls of the connecting portion form blocking surfaces, and the outer surfaces of the sidewalls of the connecting portion are provided with two guide grooves;

the second upper cover is a thin-walled shell with an accommodating space and an open bottom and one open side, and is mounted on the connecting portion in a snap-fit manner; a plurality of retaining teeth with slide slopes are projected from the inner surface of the sidewall of the second upper cover, and when the first upper cover and the second upper cover are snap-fitted, the slide slopes of the retaining teeth get across the blocking surfaces, so that the upper surfaces of the retaining teeth abut against the blocking surfaces to form snap-fit connection; a plurality of retaining teeth are projected from the inner surface of the sidewall of the second upper cover, and the retaining teeth can abut against the blocking surfaces of the first upper cover to form snap-fit connection; and two guide blocks are arranged on the inner surface of the sidewall of the second upper cover, and the guide blocks can be inserted into the guide grooves in a sliding manner.

According to the combined upper cover for a power strip, the inner surface of the sidewall of the cover body portion of the first upper cover is provided with a plurality of snap-fit fasteners for undetachable connection with a bottom board of the power strip.

According to the combined upper cover for a power strip, the front sidewall of the connecting portion of the first upper covert is provided with a U-shaped opening, and the second upper cover is provided with a power cord hole at a corresponding position for a power cord to pass through.

According to the combined upper cover for a power strip, the upper wall of the connecting portion of the first upper cover is provided with a first button hole, and the second upper cover is provided with a second button hole at a corresponding position for a button to be embedded.

According to the combined upper cover for a power strip, the upper wall of the connecting portion of the first upper cover is provided with an indicator light mounting hole for an indicator light to be embedded, and the second upper cover is provided with a light-leaking hole at a corresponding position.

According to the combined upper cover for a power strip, the first upper cover and the second upper cover when combined together have outer surfaces engaged flush with each other.

According to the combined upper cover for a power strip, the first upper cover and the second upper cover have different colors.

The advantages of the present invention are as follows:

1. The first upper cover and the second upper cover are two parts separated from each other, which can have different colors respectively, thus improving the product recognizability.

2. The combined upper covers are connected with the snap-fit fasteners, which is more stable, and the shells cannot be separated due to screws getting loose.

### BRIEF DESCRIPTION OF THE DRAWINGS

FIG. 1 is a schematic diagram of the composition of a combined upper cover;

FIG. 2 is a three-dimensional view of a first upper cover;

FIG. 3 is a three-dimensional view of the first upper cover in another direction;

FIG. 4 is a partial three-dimensional view of a snap-fit fastener;

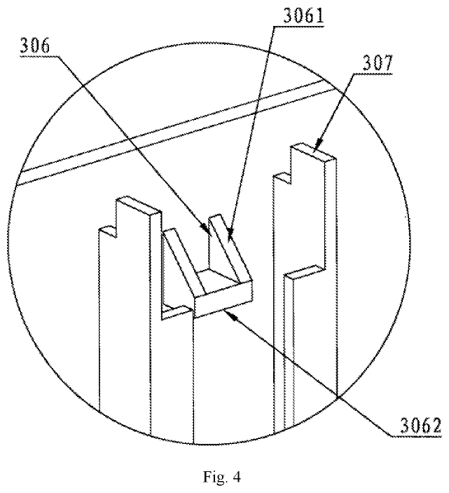

FIG. 5 is a partial three-dimensional view of a snap-fit base;

FIG. 6 is a three-dimensional view of a second upper cover; and

FIG. 7 is a three-dimensional view of the second upper cover in another direction.

### DESCRIPTION OF REFERENCE NUMERALS

10. power cord; 20. second upper cover; 201. second button hole; 202. light-leaking hole; 203. power cord hole; 204. retaining tooth; 2041. slide slope; 205. guide block; 30. first upper cover; 301. cover body portion; 302. connecting portion; 303. socket aperture; 304. first button hole; 305. indicator light mounting hole; 306. snap-fit fastener; 3061. pushing slope; 3062. positioning surface; 307. enclosure; 308. guide groove; 309. U-shaped opening; 310. blocking surface; 311. positioning post; 312. positioning wall; 40. bottom board; 401. snap-fit base; 4011. baffle; 402. positioning notch.

### DETAILED DESCRIPTION

Some specific embodiments of the present invention will be described in detail blow in an exemplary rather than limiting way with reference to the drawings. In the drawings, the same reference numerals denote the same or similar parts or portions. It should be understood by those skilled in the art that these drawings are not necessarily drawn according to a true scale.

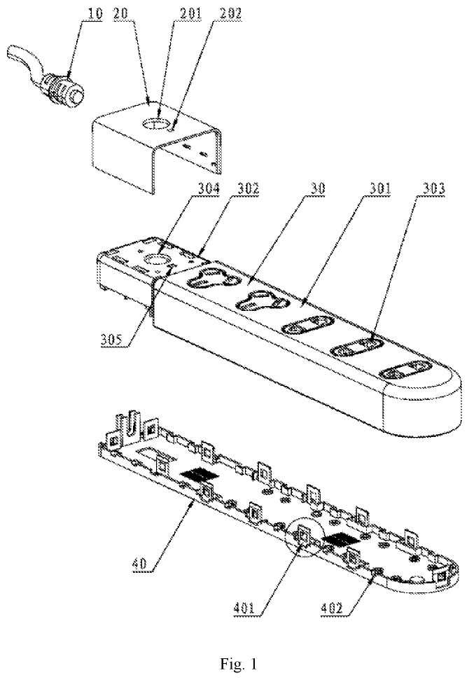

Referring to FIG. 1, the present invention provides a combined upper cover for a power strip, which is formed by combining a first upper cover 30 and a second upper cover 20. The combined upper cover is then undetachably connected to a bottom board 40 in a snap-fitting manner to form a power strip housing. A power cord 10 can be inserted from the end face and connected to each socket module inside.

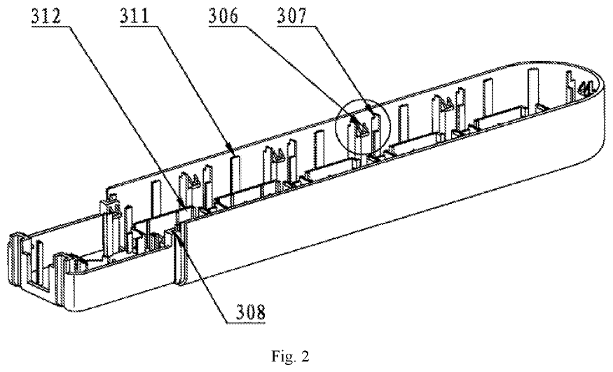

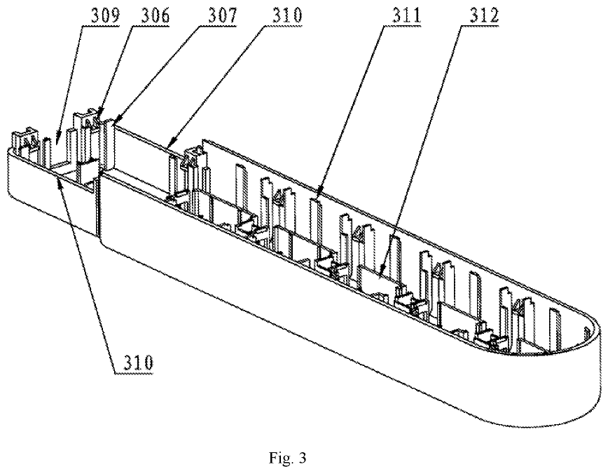

Referring to FIG. 1, FIG. 2 and FIG. 3, the first upper cover is provided with a cover body portion 301 and a connecting portion 302 integrally extending from the cover body portion 301. Both the cover body portion 301 and the connecting portion 302 are thin-walled shells with accommodating spaces, open bottoms and an n-shaped cross section.

The upper surface of the cover body portion 301 is provided with a plurality of socket apertures 303. In the present embodiment, the socket apertures 303 include two three-phase socket apertures and three two-phase socket apertures, which can supply power to five electrical devices at the same time. The inner surface of the upper wall of the cover body portion 301 is provided with a circle of positioning wall 312 corresponding to the position of each socket aperture for positioning and installing each socket module. A plurality of snap-fit fasteners 306 with pushing slopes 3061 are projected from the inner surface of the sidewall of the cover body portion 301, with the pushing slopes 3061 of the snap-fit fasteners 306 facing the bottom of the first upper cover 30. The end of each pushing slope 3061 is provided with a positioning surface 3062 for undetachable connection with the bottom board 40, and a group of enclosures 307 are arranged around each snap-fit fastener 306 for auxiliary positioning and prevention of snap-fit disconnection when the bottom board 40 is snap-fitted. The inner surface of the sidewall of the cover body portion 301 is also provided with a plurality of positioning posts 311 for being positioned in positioning notches 402 when the cover body portion 301 is undetachably connected to the bottom board 40.

The width and height of the connecting portion 302 are less than those of the cover body portion 301, and the middle of the upper surface of the connecting portion 302 is provided with a first button hole 304 and an indicator light mounting hole 305. The sidewall of the front end (the end into which the power cord is inserted) of the connecting portion 302 is provided with a U-shaped opening 309 for the power cord 10 to be inserted. Two snap-fit fasteners 306 are projected from the inner surfaces on the two sides of the U-shaped opening 309 for undetachable connection with the bottom board 40, and a group of enclosures 307 are arranged around each snap-fit fastener 306. The height of the two opposite sidewalls of the connecting portion 302 is less than that of the sidewall of the cover body portion 301, so that blocking surfaces 310 are formed at the bottoms of the sidewalls of the connecting portion 302 for being connected to the second upper cover 20 in a snap-fit manner. Two guide grooves 308 are provided at the joint between the two sidewalls of the connecting portion 302 and the two sidewalls of the cover body portion 301.

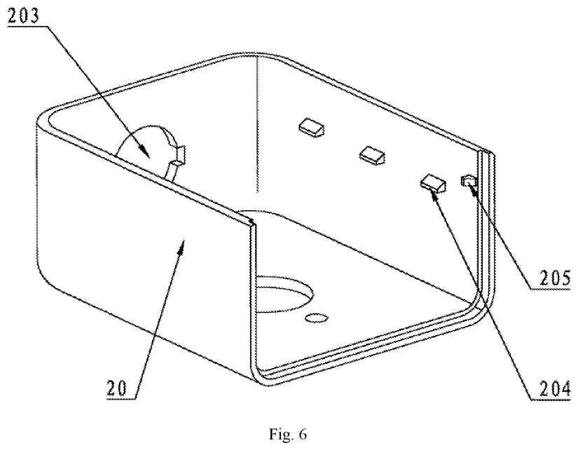

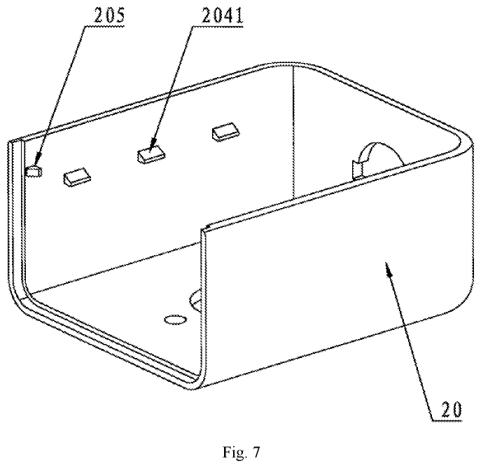

Referring to FIG. 1, FIG. 6 and FIG. 7, the second upper cover 20 is an n-shaped thin-walled shell with an accommodating space and an open bottom and open rear side. The upper surface of the second upper cover 20 is provided with a second button hole 201 and a light-leaking hole 202, and the front side of the second upper cover is provided with a power cord hole 203. The positions of the second button hole 201, the light-leaking hole 202 and the power cord hole 203 respectively correspond to the first button hole 306, the indicator light mounting hole 305 and the U-shaped opening 309. Six retaining teeth 204 with slide slopes 2041 are symmetrically projected from the inner surface of the sidewall of the second upper cover 20. The positions of the retaining teeth 204 are adapted to the height of the sidewalls of the connecting portion 302, and therefore the slide slopes 2041 of the retaining teeth 204 can get across the blocking surfaces 310, so that the upper surfaces of the retaining teeth 204 abut against the blocking surfaces 310, thus achieving the snap-fit connection between the first upper cover 30 and the second upper cover 20. Two guide blocks 205 are symmetrically projected from the inner surface of the sidewall of the second upper cover 20 near the rear end, and can be inserted into the two guide grooves 308 of the connecting portion 302 in a sliding manner, playing a guiding role.

The edge of the outer wall is provided with an opposite step in a thickness direction at the joint between the second upper cover 20 and the first upper cover 30, so that the second upper cover 20 and the first upper cover 30 can fully fit each other when lapped, with the outer surfaces flush with each other.

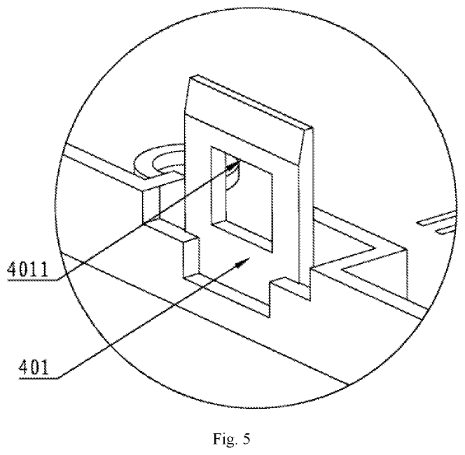

Referring to FIG. 1 and FIG. 5, the bottom board 40 is provided with a plurality of snap-fit bases 401 vertically extending upward. Each snap-fit base 401 is a rectangular sheet body, the extending end of which is wedged and the middle of which is provided with a square hole, so that a baffle 4011 for snap-fitting is formed. The bottom board 40 is also provided with a plurality of positioning notches 402 into which the positioning posts 311 can be inserted when the upper covers are combined and connected.

When the first upper cover 30 is combined with the second upper cover 20, the guide blocks 205 slide in the guide grooves 308 to play a guiding and positioning role, so that the second upper cover 20 is vertically mounted on the connecting portion 302 of the first upper cover 30 in a snap-fit manner. At the same time, the sidewalls of the connecting portion 302 come into contact with the slide slopes 2041 of the retaining teeth 204 and slide to push, forcing the second upper cover 20 to slightly deform. When the retaining teeth 204 slide to the bottom of the connecting portion 302, the second upper cover 20 is elastically restored, so that the slide slopes 2041 of the retaining teeth 204 get across the blocking surfaces 301, and consequently, the upper surfaces of the retaining teeth 204 abut against the blocking surfaces 310, achieving the snap-fit connection between the first upper cover 30 and the second upper cover 20.

After forming the combined upper cover, the first upper cover 30 and the second upper cover 30 are then undetachably connected to the bottom board 40 to form a complete housing. When the combined upper cover is connected to the bottom board 40, the positioning posts 311 of the inner wall of the first upper cover 30 are correspondingly inserted in the positioning notches 402 of the bottom board 40 to play a positioning role, and at the same time, the snap-fit bases 401 on the bottom board 40 are vertically inserted between the snap-fit fasteners 306 and the enclosures 307 of the inner wall of the combined upper cover. The pushing slopes 3061 of the snap-fit fasteners 306 push the wedged ends of the snap-fit bases 401 in a sliding manner, so that the snap-fit fasteners 306 and the snap-fit bases 401 are deflected from each other to pass through. After the ends of the pushing slopes 3061 of the snap-fit fasteners 306 are staggered from the wedged ends of the snap-fit bases 401, the elastic restoration of the snap-fit bases 401 makes the positioning surfaces 3062 of the snap-fit fasteners 306 snap-fit into the square holes of the snap-fit bases 401 and abut against the baffles 4011 of the snap-fit bases 401, so that a snap-fit connection is achieved (and the snap-fit fasteners 306 cannot get out). The enclosures 307 not only play an auxiliary positioning role in the snap-fit connection but also limit the movement of the snap-fit bases 401 toward a direction of separation, so that the snap-fit connection cannot be disassembled.

The advantages of the present invention are as follows:

Since the housing is assembled by the snap-fit fasteners in a snap-fit manner, a more stable and firmer connection can be obtained so as to avoid disconnection caused by threads getting loose that may occur in threaded connection; moreover, different colors can be sprayed on the separated upper cover assembly, improving product recognizability.

The above description is merely illustrative rather than limitative for the present invention, and those of ordinary skill in the art should understand that many modifications, changes or equivalents can be made without departing from the spirit and scope defined by the claims, but shall all fall within the protection scope of the present invention.

What is claimed is:

1. A combined upper cover for a power strip, formed by combining a first upper cover and a second upper cover; wherein
the first upper cover is provided with a cover body portion and a connecting portion integrally extending from the cover body portion, both the cover body portion and the connecting portion are thin-walled shells with an accommodating space and an open bottom, the bottom surface of the sidewall of the connecting portion forms a blocking surface, and the outer surface of the sidewall of the connecting portion is provided with two guide grooves;
the second upper cover is a thin-walled shell with an accommodating space and an open bottom and one open side, and is mounted on the connecting portion in a snap-fit manner; a plurality of retaining teeth with slide slopes are projected from the inner surface of the sidewall of the second upper cover, and when the first upper cover and the second upper cover are snap-fitted, the slide slopes of the retaining teeth get across the blocking surfaces, so that the upper surfaces of the retaining teeth abut against the blocking surfaces to form snap-fit connection; and two guide blocks are arranged on the inner surface of the sidewall of the second upper cover, and the guide block can be inserted into the guide grooves in a sliding manner.

2. The combined upper cover for a power strip of claim 1, wherein the inner surface of the sidewall of the cover body portion of the first upper cover is provided with a plurality of snap-fit fasteners for undetachable connection with a bottom board of the power strip.

3. The combined upper cover for a power strip of claim 1, wherein the front wall of the connecting portion of the first upper covert is provided with a U-shaped opening, and the second upper cover is provided with a power cord hole at a corresponding position for a power cord to pass through.

4. The combined upper cover for a power strip of claim 1, wherein the upper wall of the connecting portion of the first upper cover is provided with a first button hole, and the second upper cover is provided with a second button hole at a corresponding position for a button to be embedded.

5. The combined upper cover for a power strip of claim 1, wherein the upper wall of the connecting portion of the first upper cover is provided with an indicator light mounting hole for an indicator light to be embedded, and the second upper cover is provided with a light-leaking hole at a corresponding position.

6. The combined upper cover for a power strip of claim 1, wherein the first upper cover and the second upper cover when combined together have outer surfaces engaged flush with each other.

7. The combined upper cover for a power strip of claim 1, wherein the first upper cover and the second upper cover have different colors.
